(19) United States
(12) Patent Application Publication
(10) Pub. No.: US 2026/0152684 A1
(43) Pub. Date: Jun. 4, 2026

(54) GEL BEADS FOR CONFORMANCE CONTROL IN OIL AND GAS RESERVOIRS

(71) Applicant: Hamad Bin Khalifa University (HBKU), Doha (QA)

(72) Inventors: Ibnelwaleed Hussein, Doha (QA); Ahmed Ben Ali, Doha (QA); Reem Elaf, Doha (QA); Ahmed Hamza, Doha (QA); Mohammed Ali H. Salah Saad, Doha (QA); Abdulaziz Almakimi, Doha (QA); Fahd Alenezy, Doha (QA); Baojun Bai, Doha (QA)

(21) Appl. No.: 19/393,025

(22) Filed: Nov. 18, 2025

Related U.S. Application Data
(60) Provisional application No. 63/726,777, filed on Dec. 2, 2024.

(51) Int. Cl. C09K 8/58

(52) U.S. Cl. CPC C09K 8/58

(57) ABSTRACT

The present disclosure provides for gel beads for conformance control in oil and gas reservoirs. According to one aspect of the present disclosure gel beads for conformance control in oil and gas reservoirs. According to a second aspect of the present disclosure a method of using gel beads for conformance control in oil and gas reservoirs.

### PRIORITY CLAIM AND CROSS-REFERENCE TO RELATED APPLICATIONS

The present application claims priority to and the benefit of U.S. Provisional Patent Application No. 63/726,777 filed Dec. 2, 2024, which is incorporated herein by reference in its entirety and relied upon.

### BACKGROUND

The oilfield chemicals market is projected to grow globally because of the maturation of oil and gas reservoirs, which requires intensive treatment to maintain their recovery factors. Designed particle gels for water shut-off applications can impede water flow and achieve conformance control. However, the conventional process for preparing these particle gels involves mixing chemicals at defined ratios, heating the mixture using a chemical reactor or microwave synthesizer, blending the formed gel, purifying it to eliminate any unreacted or undesired chemicals, drying it to remove the solvent, and finally crushing it to obtain particles of various sizes. Subsequently, sieving is employed to ensure the selection of defined particle sizes. These particles are then dispersed in a fluid and allowed to swell. The swollen particles are injected into reservoirs either partially or fully swollen. The transportation and plugging mechanisms are controlled by the ratio between particle sizes and the openings, as well as the viscoelastic properties of the particle gel. The swelling process affects both the deformability and size of the particles. The conventional method involves synthesis at high temperatures, complex compositions, and sometimes toxic reagents, along with subsequent steps such as blending, purifying, drying, crushing, and sieving, which is energy, time, and cost-consuming. There is therefore a need for gel beads for conformance control in oil and gas reservoirs.

### SUMMARY

The present disclosure provides for gel beads for conformance control in oil and gas reservoirs.

According to one non-limiting aspect of the present disclosure, an exemplary embodiment of gel beads for conformance control in oil and gas reservoirs.

According to a second non-limiting aspect of the present disclosure, an exemplary embodiment of a method of using gel beads for conformance control in oil and gas reservoirs.

Additional features and advantages are described in, and will be apparent from, the following Detailed Description. The features and advantages described herein are not all-inclusive and, in particular, many additional features and advantages will be apparent to one of ordinary skill in the art in view of the description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 illustrates plugging performance of gel beads CMC/Fe after swelling triggered by ammonia, according to an example embodiment of the present disclosure;

FIG. 2 illustrates post-treatment performance evaluation of swelling trigger beads using water injection, according to an example embodiment of the present disclosure.

### DETAILED DESCRIPTION

The present disclosure generally relates to gel beads for conformance control in oil and gas reservoirs.

The disclosed technology pertains to the innovative use of gel beads for conformance control and water shut-off applications in oil and gas reservoirs, offering a superior alternative to conventional preformed particle gels. These novel gel beads are distinguished by their simple preparation process, which eliminates the need for energy-intensive and high-cost manufacturing methods. The gel beads can be prepared using nontoxic synthetic and natural polymers, addressing environmental concerns. The gel beads feature highly controllable sizes ranging from nanometers to millimeters, providing customizable options for various matrix or fracture plugging. The gel beads can be injected directly after preparation, a unique feature. In addition to their responsive swelling behavior, which can be triggered under specific conditions. These features enhance the adaptability and efficiency of the gel beads in managing water production and improving oil recovery.

The disclosed technology is a type of material known as hydrogel beads or gel beads. Hydrogel beads are superabsorbent materials easily produced by ionotropic gelation with multivalent ions at room temperature, streamlining manufacturing costs. Most formulations are based on cost-effective natural polymers, ensuring eco-friendliness and safe injection into reservoirs without environmental harm. The process of making gel beads is simple and does not require heat, crushing, or drying as conventional performed particle gels, which significantly reduces the energy, time, and cost of the production process. Moreover, hydrogel beads offer more controllable size ranges, from micrometers to millimeters and even down to the nanometer scale, while retaining material properties.

The disclosed technology can be used in different applications in oil and gas operations such as plugging of channels (more than 1 Darcy), sealing of high permeable zones, loss circulation prevention during drilling, water shut-off in oil and gas reservoirs, macro cracks sealing, wettability alteration to enhance oil recovery, combined with other enhance oil recovery techniques (such as low salinity water flooding, surfactant flooding, and polymer flooding) to improve their efficiency.

The proposed gel bead systems (Carboxymethyl Cellulose (CMC) Crosslinked with Iron (CMC/Fe), Sulfonated Polyacrylamide (SPAM) Crosslinked with Iron (SPAM/Fe), Carboxymethyl Cellulose Crosslinked with Aluminum (CMC/Al), and Chitosan Beads (Csb)) have not been used before as gel beads for conformance control applications in oil and gas reservoirs. The gel beads can be generated from natural and synthetic polymers with chemical properties similar to those suggested by the systems through ionotropic gelation or precipitation in non-solvents. The beads can be injected directly into the reservoir post-preparation as wet beads or after a drying process followed by swelling. Certain formulations feature unique dormant properties, activating only upon exposure to specific triggering fluids, ensuring precise localization, deep transportation, and efficient sealing. Hydrogel beads represent a significant advancement in water shut-off technology, offering simplicity, eco-friendliness, size control, and innovative sealing mechanisms, poised to revolutionize conformance control techniques and environmental sustainability.

Four materials have been developed and extensively studied: carboxymethyl cellulose (CMC) crosslinked with Iron (CMC/Fe), sulfonated polyacrylamide (SPAM) crosslinked with iron (SPAM/Fe), carboxymethyl cellulose crosslinked with aluminum (CMC/Al), and chitosan beads (Csb). CMC/Fe and SPAM/Fe exhibited similar behavior and could only swell in the presence of a base like NH4OH or NaOH (swelling trigger agent). The swelling ratios reach up to 288 g/g and 6.4 g/g in deionized water and brine with a total dissolved solids (TDS) of 67.3 g/l, respectively. In 2% KCl, their swelling ratio reaches 43.2 g/g, with particle sizes expanding from 899 μm to 4 mm. Swollen CMC/Fe beads demonstrated thermal stability after aging at 80° C., showing continued structural expansion over time in brines with TDS of 33.64 g/l and 67.3 g/l. Wet beads, while not swelling, maintain thermal stability at 100° C. in brines with TDS of 67.3 g/l and 200 g/l, ensuring their robustness under reservoir conditions.

The disclosed technology presents the development of gel beads and the process of making them to address the challenges of excess water production and achieve conformance control in oil and gas reservoirs. The beads, which can be generated from both natural and synthetic polymers through ionotropic gelation or precipitation in non-solvents, offer significant improvements over conventional particle gels by reducing synthesis times, manufacturing costs, and the need for toxic reagents, as well as eliminating subsequent processing steps such as blending, purifying, drying, crushing, sieving. The beads can be injected as wet beads directly after preparation. In this case, their plugging mechanism is based on deformation, bypassing the need for synthesis, blending, drying, crushing, sieving, and even the swelling processes that occur with conventional gel particles. Another notable innovation in the disclosed technology is the formulation of beads with a swelling trigger. These beads can be injected after drying in a dispersed solution without initial expansion, and upon encountering a basic environment or the injection of a base, they swell, expand, and effectively plug openings in the reservoir.

Four materials have been developed and extensively studied: Carboxymethyl Cellulose (CMC) Crosslinked with Iron (CMC/Fe), Sulfonated Polyacrylamide (SPAM) Crosslinked with Iron (SPAM/Fe), Carboxymethyl Cellulose Crosslinked with Aluminum (CMC/Al), and Chitosan Beads (Csb). CMC/Fe and SPAM/Fe are prepared by ionotropic gelation using simple extrusion techniques, exhibiting similar behavior with swelling ratios reaching up to 288 g/g in deionized water and 6.4 g/g in brine with a TDS of 67.3 g/l. In 2% KCl, their swelling ratio reaches 43.2 g/g, with particle sizes expanding from 899 μm to 4 mm. CMC/Al is also prepared by ionotropic gelation, while Csb is created through chitosan precipitation in sodium hydroxide, with both showing similar swelling characteristics.

The development of viscoelastic beads using aluminum lactate with CMC enables deformation without crushing, while other aluminum compounds such as aluminum sulfate, aluminum acetate, and aluminum nitrate form easily crushed beads. These variations offer flexibility in tailoring bead properties for specific applications. Swollen CMC/Fe beads demonstrate thermal stability after aging at 80° C., showing continued structural expansion in brines with TDS of 33.64 g/l and 67.3 g/l. Wet beads, while not swelling, maintain thermal stability at 100° C. in brines with TDS of 67.3 g/l and 200 g/l. This ensures their robustness under reservoir conditions. For optimal application, injecting Csb or CMC/Al directly after preparation as wet beads is recommended, thus eliminating the need for drying and swelling processes and relying on particle deformation for effective plugging. Ferrogels such as CMC/Fe and SPAM/Fe can be injected either partially or fully swollen into brine mixed with a base like ammonia or sodium hydroxide. The ideal method involves dispersing these beads in brine and introducing the base afterward to trigger swelling. This ensures that the beads flow without initial swelling and expand upon encountering the base, effectively sealing the target area. This innovative approach provides a more efficient and cost-effective solution for managing excess water production and enhancing conformance control in oil and gas operations, representing a significant advancement over existing technologies.

The developed beads were tested in the laboratory and proved a good candidate for water shut-off treatment. Four systems have been developed: carboxymethyl cellulose crosslinked with Iron (CMC/Fe), carboxymethyl cellulose crosslinked with Aluminum (CMC/Al), sulfonated polyacrylamide crosslinked with Iron (SPAM/Fe), and gel beads-based chitosan and sodium hydroxide (Csb). Fourier Transform Infrared Spectroscopy (FTIR) spectroscopy was utilized to analyze the functional groups of the prepared beads. High-resolution scans were performed over a 500-4000 cm-1 wavenumber range for each sample using Perkin Elmer Spectrum.

The thermal analysis was performed by using Thermo-gravimetric analysis (TGA) Perkin Elmer Pyris 1. The experiment was conducted in nitrogen (30 mL/min) condition from 25° C. to 800° C. with a heating rate of 10° C./minute. A scanning electron microscope (SEM) was used to show the morphological structures of dried and wet beads in case of swelling. Before the SEM analysis, wet and swollen beads were passed through three freeze-drying stages for 48 hours using the Labconco FreeZone 12 machine. The drying stages were as follows: (1) The samples were placed in the freeze-dryer chamber and chilled to −50° C. at 0.6° C./minute and isothermal plateau for two hours; (2) The samples underwent a sublimation stage at a temperature of −15° C. and a total gas pressure of 18 Pa, (3) The samples were then dried at a warmer shelf temperature of 25° C. under a pressure of 10 Pa to reduce the residual moisture content to optimum values. After that, the FEI Nova Nano SEM 450 microscope was used to conduct the SEM test. The dry beads were processed without the need for the freeze-drying step. The pore sizes and particle size distribution were measured by processing the photos produced using ImageJ software.

The swelling behavior of the beads (water absorption capacity) was studied in deionized water, 2% KCl, and brine solutions. Soaking the material in brine solution determined the kinetic effects of swelling and aging. The gravimetric method was used in each experiment, where 0.5 g of dry beads was immersed in a 100 ml solution. Then, the swollen beads were separated by filtration. The net weight of the swollen beads was measured, and the swelling ratio was determined using the equation 1:(SR=(W_s−W_d)/W_s #(1)). Where W_s is the weight after swelling and W_d is the dried beads' weight. The kinetics were made at different periods, up to 24 hours.

The effect of temperature was investigated in an oil bath at temperatures ranging from 25-100° C. for one day. The brine samples were prepared in the laboratory by dissolving pure salts in deionized water. The composition of brine 1, brine 2, brine 3, and brine 4 (Table 1) with the total dissolved salinity (TDS) of 16.8 g/1, 33.6 g/l, and 67.3 g/l, and 200 g/l, respectively, represent the condition found in oil reservoirs in Gulf countries that can be treated to achieve conformance control.

TABLE 1
Composition of Synthetic Seawater and produced water

| | Brine 1 | Brine 2 | Brine 3 | Brine 4 |
|---|---|---|---|---|
| Salts | Concentration (g/L) | Concentration (g/L) | Concentration (g/L) | Concentration (g/L) |
| NaHCO3 | 0.05955 | 0.1191 | 0.2382 | 2.015 |
| Na2SO4 | 1.64385 | 3.2877 | 6.5754 | 2.587 |
| CaCl2•H2O | 0.5986 | 1.1972 | 2.3945 | 6.098 |
| MgCl2•6H2O | 4.56345 | 9.1269 | 18.0539 | 49.599 |
| NaCl | 10.06845 | 20.1369 | 40.2738 | 137.273 |
| CaCO3 | 0 | 0 | 0 | 1.628 |
| KCl | 0 | 0 | 0 | 0.8 |
| TDS | 16.8244 | 33.6488 | 67.2976 | 200 |

The rheological properties of the developed materials were investigated using an Anton Paar rheometer (MCR 304) on parallel plate geometry at ambient conditions. The gap between the upper and lower plate was kept at 2 mm during all the experiments.

To evaluate the plugging efficiency of CMC/Fe beads, a dynamic core flooding experiment was conducted in a fractured sandstone. A conventional core flooding setup was utilized, consisting mainly of an ISCO pump connected to two accumulators and a core holder. The sandstone core was placed in the oven at 120° C. to eliminate residual water, then placed in a vacuum chamber for 24 hours. The core was then saturated with 2% KCl brine overnight. Porosity was measured using the weight method, and matrix permeability at various flow rates was calculated using Darcy's law. The saturated sandstone core was split into two halves using an electrical saw to construct the fracture model. Two stainless-steel strips with the desired fracture thickness were affixed to the inner surface of the split core. The assembled fractured sandstone was wrapped with Teflon and placed in the core holder. After securing the connection lines, a confining pressure greater than the injection pressure by at least 500 psi was core to be at least 500 psi higher than the injection pressure.

Initial water flooding was started at a flow rate=1.00 cm³/min until the pressure stabilized. CMC/Fe dry beads of average particle size of 899 μm) were subjected to swelling in 2% KCl in the presence of 0.25% NH4OH. A fixed amount of swollen ferrogel beads was placed in the accumulator to be injected into the fractured sandstone at a 1.00 cm³/min flow rate. After the gel injection was terminated, all lines were cleaned and reconnected to perform post-water flooding. Post-water flooding was performed at different injection flow rates of 0.10, 0.25, 0.50, 0.75, and 1.00 cm³/min until the pressure stabilizes for each flow rate to determine the permeability of the fractured model. The residual resistance factor (Frr) is commonly used to describe the plugging efficiency of the placed gel at a given q and is calculated from the equation below: (F_rr=(K_b/μ_w)/(K_a/μ_w) #(3)). Where, Kb is the initial permeability of the fractured sandstone model, including matrix and fracture. Ka is the permeability of the fractured sandstone model after the CMC/CPAM-PPG placement. μw is the viscosity of the brine. q is the injection flow rate. The plugging efficiency can be calculated using the equation: (Plugging Efficiency=(1−1/F_rr)*100% #(4)).

A second core flooding experiment was carried out to evaluate the sealing and conformance control performance of CMC/Fe-based gel beads. The sandstone core used in this study had a length of 37.59 mm, a fracture width of approximately 2 mm, and a permeability of 60 mD. The gel beads were designed to be injected in their unswollen state to ensure smooth propagation through the fracture without blocking the injection line. The swelling of the beads was subsequently triggered in situ by introducing an ammonia-based activating solution.

A total of 5 mL of unswollen CMC/Fe beads were manually packed within the fracture section of the sandstone core. Prior to the swelling activation, a baseline permeability measurement was performed by injecting a 2 wt. % KCl brine solution at a flow rate of 0.5 mL/min for 1 hour to establish the initial pressure drop and ensure fracture saturation. Following this stage, an activating solution composed of 2 wt. % KCl containing ammonia (5 wt. %) was injected at a constant flow rate of 0.067 mL/min for 5 hours, corresponding to approximately twice the fracture volume (˜20 mL). Upon contact with ammonia, a chemical reaction occurred within the CMC/Fe beads, which initiated water absorption through osmotic and electrostatic interactions, leading to gradual volumetric expansion of the hydrogel network. This swelling process started after a delay period of about 90 minutes, as indicated by the progressive rise in differential pressure (ΔP) recorded across the core. The pressure continued to increase as the beads expanded, effectively filling the fracture and restricting brine flow through the system. The water breakthrough pressure reached approximately 49.19 psi, confirming that the beads provided a robust seal within the fracture without damaging the rock matrix.

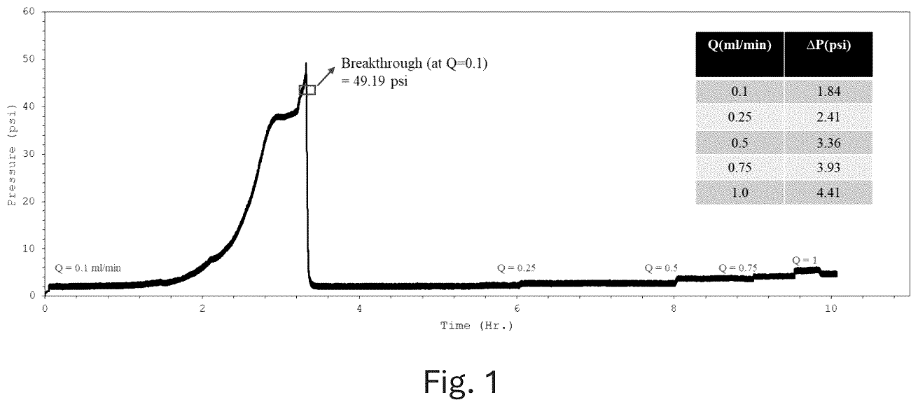

Following the ammonia-triggered swelling phase, a post-flooding test was conducted using 2 wt. % KCl solution at incremental flow rates of 0.1, 0.25, 0.5, 0.75, and 1.0 mL/min. The pressure difference (ΔP) was recorded for each rate, as shown in FIG. 1, and the corresponding apparent permeability values (Ka) were calculated using Darcy's law. The residual resistance factor (Frr) was determined using the ratio of the initial permeability before treatment (Kb) to the apparent permeability after gel swelling (Ka).

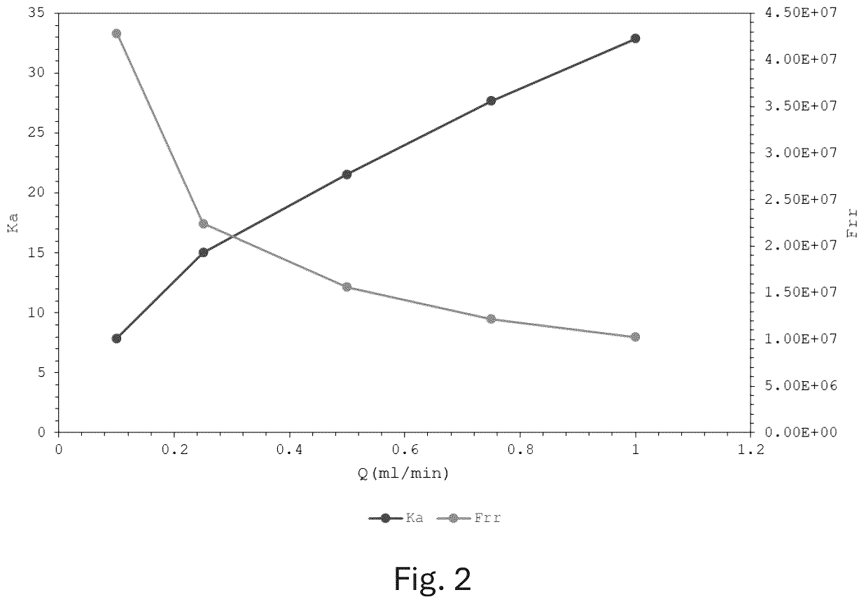

The calculated results, shown in FIG. 2, demonstrate that Ka decreased significantly after gel swelling, indicating strong flow restriction within the fracture. The Frr values ranged from 4.28×10⁷ at 0.1 mL/min to 1.03×10⁷ at 1.0 mL/min, signifying a highly efficient plugging behavior (≈87%) even under elevated flow conditions. The observed trend shows that as the flow rate increased, the apparent permeability slightly increased due to minor deformation and rearrangement of the gel structure under shear stress; however, the system maintained effective sealing capability.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. Gel beads for conformance control in oil and gas reservoirs, wherein the beads are configured to selectively swell.

2. The gel beads of claim 1, wherein the gel beads are prepared using ionotropic gelation or precipitation in non-solvents.

3. The gel beads of claim 1, wherein the gel beads are comprised of natural and synthetic fibers.

4. The gel beads of claim 1, wherein the gel beads are injected after drying in a dispersed solution.

5. The gel beads of claim 4, wherein the gel beads selectively swell via presence in a basic environment or the injection of a base.

6. The gel beads of claim 5, wherein the base is one of ammonia or NaOH.

7. The gel beads of claim 1, wherein the gel beads are injected as wet beads directly after preparation.

8. The gel beads of claim 1, wherein the gel beads are comprised of one of Carboxymethyl Cellulose (CMC) Crosslinked with Iron (CMC/Fe), Sulfonated Polyacrylamide (SPAM) Crosslinked with Iron (SPAM/Fe), Carboxymethyl Cellulose Crosslinked with Aluminum (CMC/Al), or Chitosan Beads (Csb).

9. The gel beads of claim 8, wherein gel beads comprised of CMC/Fe are prepared by ionotropic gelation using simple extrusion.

10. The gel beads of claim 8, wherein gel beads comprised of SPAM/Fe are prepared by ionotropic gelation using simple extrusion.

11. The gel beads of claim 8, wherein gel beads comprised of CMC/Al is are prepared by ionotropic gelation.

12. The gel beads of claim 8, wherein gel beads comprised of Cab are prepared by chitosan precipitation in sodium hydroxide.

13. A method of using gel beads for conformance control in oil and gas reservoirs.
